(19) United States
(12) Patent Application Publication
(10) Pub. No.: US 2025/0062887 A1
(43) Pub. Date: Feb. 20, 2025

(54) RESOURCE CONFIGURATION METHOD AND RELATED APPARATUS

(71) Applicant: HUAWEI TECHNOLOGIES CO., LTD., Shenzhen (CN)

(72) Inventors: Ying CHEN, Hangzhou (CN); Jianwei ZHOU, Hangzhou (CN); Jun WANG, Hangzhou (CN); Dali QIN, Hangzhou (CN); Yinggang DU, Shenzhen (CN)

(21) Appl. No.: 18/939,007

(22) Filed: Nov. 6, 2024

Related U.S. Application Data
(63) Continuation of application No. PCT/CN2023/090666, filed on Apr. 25, 2023.

(30) Foreign Application Priority Data
May 10, 2022 (CN) 202210505105.7

(51) Int. Cl. H04L 5/14; H04W 72/0446

(52) U.S. Cl. CPC H04L 5/14; H04W 72/0446

(57) ABSTRACT

This application provides a resource configuration method and a related apparatus. The method includes: A first terminal device receives first configuration information used to configure a first time division duplex frame structure. Because an interval between adjacent uplink time domain resources in the first time division duplex frame structure is determined based on a largest timing advance and a smallest timing advance in a terminal device that uses the first time division duplex frame structure, and the terminal device that uses the first time division duplex frame structure includes the first terminal device, after the first terminal device sends uplink data on a first uplink time domain resource in the first time division duplex frame structure by using a first timing advance, when the uplink data arrives at a network device, a time domain resource that can be used by the network device is an uplink time domain resource.

### CROSS-REFERENCE TO RELATED APPLICATIONS

This application is a continuation of International Application No. PCT/CN2023/090666, filed on Apr. 25, 2023, which claims priority to Chinese Patent Application No. 202210505105.7, filed on May 10, 2022, the disclosures of the aforementioned applications are hereby incorporated by reference in their entireties.

### TECHNICAL FIELD

This application relates to the field of communication technologies, and in particular, to a resource configuration method and a related apparatus.

### BACKGROUND

In a large-delay communication scenario, for example, satellite communication, a time division duplex (time division duplex, TDD) communication manner may be used. When the TDD communication manner is used, one slot may be used for uplink sending or downlink sending. Generally, a terminal device may send uplink data in one slot by using a timing advance. However, because a large timing advance needs to be introduced in the large-delay communication scenario to implement uplink signal synchronization, after the terminal device sends the uplink data in one slot by using the timing advance, reception of the uplink data may conflict with sending of downlink data. Therefore, when the TDD communication manner is used, how to prevent a conflict between the reception of the uplink data and the sending of the downlink data becomes a technical problem to be urgently resolved currently.

### SUMMARY

One or more embodiments of the present application provide a resource configuration method and a related apparatus, to resolve a problem of a conflict between reception of uplink data and sending of downlink data when a TDD communication manner is used.

According to a first aspect, a resource configuration method is provided. The method includes: A first terminal device receives first configuration information, where the first configuration information is used to configure a first time division duplex frame structure; and the first terminal device sends uplink data on a first uplink time domain resource in the first time division duplex frame structure by using a first timing advance, where an interval between adjacent uplink time domain resources in the first time division duplex frame structure is determined based on a largest timing advance and a smallest timing advance in a terminal device that uses the first time division duplex frame structure. It can be learned that the first terminal device receives the first configuration information used to configure the first time division duplex frame structure. Because the interval between the adjacent uplink time domain resources in the first time division duplex frame structure is determined based on the largest timing advance and the smallest timing advance in the terminal device that uses the first time division duplex frame structure, and the terminal device that uses the first time division duplex frame structure includes the first terminal device, after the first terminal device sends the uplink data on the first uplink time domain resource in the first time division duplex frame structure by using the first timing advance, when the uplink data arrives at a network device, a time domain resource that can be used by the network device is an uplink time domain resource. Therefore, the network device can receive the uplink data on the uplink time domain resource, to resolve a problem of a conflict between reception of the uplink data and sending of downlink data when a TDD communication manner is used.

In some embodiments, with reference to the first aspect, the interval between the adjacent uplink time domain resources in the first time division duplex frame structure is a difference between the largest timing advance and the smallest timing advance in the terminal device that uses the first time division duplex frame structure. It can be learned that, because the interval between the adjacent uplink time domain resources in the first time division duplex frame structure may be the difference between the largest timing advance and the smallest timing advance in the terminal device that uses the first time division duplex frame structure, and the terminal device that uses the first time division duplex frame structure includes the first terminal device, after the first terminal device sends the uplink data on the uplink time domain resource in the first time division duplex frame structure by using the first timing advance, when the uplink data arrives at the network device, the time domain resource that can be used by the network device is the uplink time domain resource. Therefore, the network device can receive the uplink data on the uplink time domain resource, to resolve the problem of the conflict between the reception of the uplink data and the sending of the downlink data when the TDD communication manner is used.

In some embodiments, with reference to the first aspect, the terminal device that uses the first time division duplex frame structure includes all terminal devices in a cell managed by the network device; or the terminal device that uses the first time division duplex frame structure includes all terminal devices in one or more user groups, and the one or more user groups include a first user group to which the first terminal device belongs. It can be learned that, because the terminal device that uses the first time division duplex frame structure includes all the terminal devices in the cell managed by the network device, or the terminal device that uses the first time division duplex frame structure includes all the terminal devices in the one or more user groups, when the first time division duplex frame structure is a cell-level or user group-level frame structure, and the uplink data arrives at the network device, the time domain resource that can be used by the network device is the uplink time domain resource. Therefore, the network device can receive the uplink data on the uplink time domain resource, to resolve the problem of the conflict between the reception of the uplink data and the sending of the downlink data when the TDD communication manner is used.

In some embodiments, with reference to the first aspect, an interval between adjacent uplink time domain resources corresponding to each user group in the first time division duplex frame structure is determined based on a largest timing advance and a smallest timing advance of the user group. It can be learned that, because the interval between the adjacent uplink time domain resources corresponding to each user group in the first time division duplex frame structure is determined based on the largest timing advance and the smallest timing advance of the user group, intervals between adjacent uplink time domain resources corresponding to different user groups are different. Therefore, when uplink data of different user groups arrives at the network device, the time domain resource that can be used by the network device is the uplink time domain resource, so that the network device can receive the uplink data on the uplink time domain resource, to resolve a problem of a conflict between reception of the uplink data corresponding to different user groups and sending of downlink data when the TDD communication manner is used.

In some embodiments, with reference to the first aspect, the first timing advance is greater than or equal to a smallest timing advance of the first user group and is less than a largest timing advance of the first user group, and the first uplink time domain resource is an uplink time domain resource corresponding to the first user group. It can be learned that, because the first timing advance is between the largest timing advance and the smallest timing advance of the first user group, and an interval between adjacent uplink time domain resources corresponding to the first user group is determined based on the largest timing advance and the smallest timing advance of the first user group, the first terminal device may learn that an uplink time domain resource that can be used is an uplink time domain resource in the first user group, and may further send the uplink data on the uplink time domain resource that can be used.

In some embodiments, with reference to the first aspect, the first user group is associated with a first bandwidth part, and time domain resources of the first user group in the first bandwidth part have one transmission direction. It can be learned that, because the first bandwidth part is on one frequency band, and the time domain resources of the first user group in the first bandwidth part have one transmission direction, a terminal device in the first user group can send only uplink data or only downlink data on a same frequency band, to resolve a problem of a conflict between reception of uplink data corresponding to a same user group and sending of downlink data when the TDD communication manner is used.

In some embodiments, with reference to the first aspect, the plurality of user groups further include a second user group, the second user group is associated with a second bandwidth part, and an uplink time domain resource of the first user group in the first bandwidth part is different from an uplink time domain resource of the second user group in the second bandwidth part. It can be learned that, because different bandwidth parts are on different frequency bands, and uplink time domain resources of different user groups in different bandwidth parts are different, when terminal devices in different user groups send uplink data on corresponding uplink time domain resources, there is no mutual interference.

In some embodiments, with reference to the first aspect, a guard period in the first time division duplex frame structure is determined based on the largest timing advance of the first user group to which the first terminal device belongs, and the first user group is one of a plurality of user groups in the cell managed by the network device. It can be learned that, because the guard period in the first time division duplex frame structure is determined based on the largest timing advance of the first user group to which the first terminal device belongs, the first timing advance is less than or equal to the largest timing advance of the first user group. In other words, the first timing advance is less than or equal to the guard period in the first time division duplex frame structure. In this way, after the first terminal device sends the uplink data on the uplink time domain resource in the first time division duplex frame structure by using the first timing advance, when the uplink data arrives at the network device, a time domain resource that can be used by the network device is the uplink time domain resource. Therefore, the network device can receive the uplink data on the uplink time domain resource, to resolve the problem of the conflict between the reception of the uplink data and the sending of the downlink data when the TDD communication manner is used. In addition, because the first user group is one of the plurality of user groups in the cell managed by the network device, and the guard period in the first time division duplex frame structure is determined based on the largest timing advance of the first user group to which the first terminal device belongs, the guard period in the first time division duplex frame structure is less than a largest timing advance of the cell managed by the network device. It should be understood that, because data cannot be received or sent in the guard period, when the guard period is less than the largest timing advance of the cell managed by the network device, resource utilization can be improved.

In some embodiments, with reference to the first aspect, a difference between the largest timing advance and the smallest timing advance of the first user group is less than a difference between the largest timing advance and a smallest timing advance in the cell managed by the network device. It can be learned that, because the difference between the largest timing advance and the smallest timing advance of the first user group is less than the difference between the largest timing advance and the smallest timing advance in the cell managed by the network device, and the guard period in the first time division duplex frame structure is determined based on the largest timing advance of the first user group to which the first terminal device belongs, the guard period is less than the largest timing advance in the cell managed by the network device. Because the data cannot be received or sent in the guard period, when the guard period is less than the largest timing advance of the cell managed by the network device, resource utilization can be improved.

In some embodiments, with reference to the first aspect, the method further includes: The first terminal device receives second configuration information, where the second configuration information is used to configure at least one of the following: the guard period in the first time division duplex frame structure and the interval between the adjacent uplink time domain resources in the first time division duplex frame structure. It can be learned that, the guard period in the first time division duplex frame structure and/or the interval between the adjacent uplink time domain resources in the first time division duplex frame structure may be configured by the network device. This avoids a process in which the first terminal device determines the guard period in the first time division duplex frame structure and/or the interval between the adjacent uplink time domain resources in the first time division duplex frame structure, so that energy consumption is reduced.

In some embodiments, with reference to the first aspect, the first time division duplex frame structure is a time division duplex frame structure of all terminal devices in the first user group, and the method further includes: The first terminal device receives third configuration information, where the third configuration information is used to configure a second time division duplex frame structure, and the second time division duplex frame structure is a time division duplex frame structure of the first terminal device; and the first terminal device updates the first time division duplex frame structure to the second time division duplex frame structure. It can be learned that, when the first time division duplex frame structure is the time division duplex frame structure of all the terminal devices in the first user group, that is, when the first time division duplex frame structure is a user group-level frame structure, the first terminal device may further receive the third configuration information used to configure the second time division duplex frame structure, to update the user group-level frame structure to a user-level time division duplex frame structure, so that the first terminal device can send and receive data by using the user-level time division duplex frame structure, and a delay is reduced.

In some embodiments, with reference to the first aspect, the method further includes: The first terminal device sends assistance information, where the assistance information includes at least one of the following: location information of the first terminal device and the first timing advance. It can be learned that, the first terminal device may send the assistance information, so that the network device can generate the user-level time division duplex frame structure based on the assistance information, and deliver configuration information used to configure the user-level time division duplex frame structure. Therefore, the first terminal device can send and receive data by using the user-level time division duplex frame structure, and a delay is reduced.

In some embodiments, with reference to the first aspect, the terminal device that uses the first time division duplex frame structure includes all the terminal devices in the plurality of user groups, the plurality of user groups include the first user group to which the first terminal device belongs and the second user group to which a second terminal device belongs, and the method further includes: The first terminal device receives fourth configuration information, where the fourth configuration information is used to configure a first polarization direction corresponding to the first terminal device on the first uplink time domain resource in the first time division duplex frame structure, and configure a second polarization direction corresponding to the second terminal device on a first downlink time domain resource in the first time division duplex frame structure, where the first uplink time domain resource overlaps the first downlink time domain resource, and the first polarization direction is different from the second polarization direction. It can be learned that, for terminal devices in different user groups, the network device may configure different polarization directions at a location at which time domain resources in different transmission directions collide, so that uplink and downlink of the terminal devices in different user groups are not interfered, to resolve the problem of the conflict between the reception of the uplink data corresponding to different user groups and the sending of the downlink data when the TDD communication manner is used.

For beneficial effects of the second aspect to the fourth aspect, refer to the first aspect. Details are not described herein again.

According to a second aspect, a resource configuration method is provided. The method includes: A network device generates first configuration information, where the first configuration information is used to configure a first time division duplex frame structure; the network device sends the first configuration information; and the network device receives uplink data on a first uplink time domain resource in the first time division duplex frame structure, where an interval between adjacent uplink time domain resources in the first time division duplex frame structure is determined based on a largest timing advance and a smallest timing advance in a terminal device that uses the first time division duplex frame structure.

In some embodiments, with reference to the second aspect, the interval between the adjacent uplink time domain resources in the first time division duplex frame structure is a difference between the largest timing advance and the smallest timing advance in the terminal device that uses the first time division duplex frame structure.

In some embodiments, with reference to the second aspect, the terminal device that uses the first time division duplex frame structure includes all terminal devices in a cell managed by the network device; or the terminal device that uses the first time division duplex frame structure includes all terminal devices in one or more user groups, and the one or more user groups include a first user group to which a first terminal device belongs.

In some embodiments, with reference to the second aspect, an interval between adjacent uplink time domain resources corresponding to each user group in the first time division duplex frame structure is determined based on a largest timing advance and a smallest timing advance of the user group.

In some embodiments, with reference to the second aspect, the first timing advance is greater than or equal to a smallest timing advance of the first user group and is less than a largest timing advance of the first user group, and the first uplink time domain resource is an uplink time domain resource corresponding to the first user group.

In some embodiments, with reference to the second aspect, the first user group is associated with a first bandwidth part, and time domain resources of the first user group in the first bandwidth part have one transmission direction.

In some embodiments, with reference to the second aspect, the plurality of user groups further include a second user group, the second user group is associated with a second bandwidth part, and an uplink time domain resource of the first user group in the first bandwidth part is different from an uplink time domain resource of the second user group in the second bandwidth part.

In some embodiments, with reference to the second aspect, a guard period in the first time division duplex frame structure is determined based on the largest timing advance of the first user group to which the first terminal device belongs, and the first user group is one of a plurality of user groups in the cell managed by the network device.

In some embodiments, with reference to the second aspect, a difference between the largest timing advance and the smallest timing advance of the first user group is less than a difference between the largest timing advance and a smallest timing advance in the cell managed by the network device.

In some embodiments, with reference to the second aspect, the method further includes: The network device sends second configuration information, where the second configuration information is used to configure at least one of the following: the guard period in the first time division duplex frame structure and the interval between the adjacent uplink time domain resources in the first time division duplex frame structure.

In some embodiments, with reference to the second aspect, the first time division duplex frame structure is a time division duplex frame structure of all terminal devices in the first user group, and the method further includes: The network device generates third configuration information, where the third configuration information is used to configure a second time division duplex frame structure; and the network device sends the third configuration information.

In some embodiments, with reference to the second aspect, the method further includes: The network device receives assistance information, where the assistance information includes at least one of the following: location information of the first terminal device or the timing advance of the first terminal device; and that the network device generates third configuration information includes: The network device generates the third configuration information based on the assistance information.

In some embodiments, with reference to the second aspect, the terminal device that uses the first time division duplex frame structure includes all the terminal devices in the plurality of user groups, the plurality of user groups include the first user group to which the first terminal device belongs and the second user group to which a second terminal device belongs, and the method further includes: The network device sends fourth configuration information, where the fourth configuration information is used to configure a first polarization direction corresponding to the first terminal device on the first uplink time domain resource in the first time division duplex frame structure, and configure a second polarization direction corresponding to the second terminal device on a first downlink time domain resource in the first time division duplex frame structure, where the first uplink time domain resource overlaps the first downlink time domain resource, and the first polarization direction is different from the second polarization direction.

According to a third aspect, a communication apparatus is provided. The communication apparatus is a first terminal device, the first terminal device includes a transceiver module, and the transceiver module is configured to: receive first configuration information, where the first configuration information is used to configure a first time division duplex frame structure; and send uplink data on a first uplink time domain resource in the first time division duplex frame structure by using a first timing advance, where an interval between adjacent uplink time domain resources in the first time division duplex frame structure is determined based on a largest timing advance and a smallest timing advance in a terminal device that uses the first time division duplex frame structure.

In some embodiments, with reference to the third aspect, the interval between the adjacent uplink time domain resources in the first time division duplex frame structure is a difference between the largest timing advance and the smallest timing advance in the terminal device that uses the first time division duplex frame structure.

In some embodiments, with reference to the third aspect, the terminal device that uses the first time division duplex frame structure includes all terminal devices in a cell managed by a network device; or the terminal device that uses the first time division duplex frame structure includes all terminal devices in one or more user groups, and the one or more user groups include a first user group to which the first terminal device belongs.

In some embodiments, with reference to the third aspect, an interval between adjacent uplink time domain resources corresponding to each user group in the first time division duplex frame structure is determined based on a largest timing advance and a smallest timing advance of the user group.

In some embodiments, with reference to the third aspect, the first timing advance is greater than or equal to a smallest timing advance of the first user group and is less than a largest timing advance of the first user group, and the first uplink time domain resource is an uplink time domain resource corresponding to the first user group.

In some embodiments, with reference to the third aspect, the first user group is associated with a first bandwidth part, and time domain resources of the first user group in the first bandwidth part have one transmission direction.

In some embodiments, with reference to the third aspect, the plurality of user groups further include a second user group, the second user group is associated with a second bandwidth part, and an uplink time domain resource of the first user group in the first bandwidth part is different from an uplink time domain resource of the second user group in the second bandwidth part.

In some embodiments, with reference to the third aspect, a guard period in the first time division duplex frame structure is determined based on the largest timing advance of the first user group to which the first terminal device belongs, and the first user group is one of a plurality of user groups in the cell managed by the network device.

In some embodiments, with reference to the third aspect, a difference between the largest timing advance and the smallest timing advance of the first user group is less than a difference between a largest timing advance and a smallest timing advance in the cell managed by the network device.

In some embodiments, with reference to the third aspect, the transceiver module is further configured to receive second configuration information, where the second configuration information is used to configure at least one of the following: the guard period in the first time division duplex frame structure and the interval between the adjacent uplink time domain resources in the first time division duplex frame structure.

In some embodiments, with reference to the third aspect, the first time division duplex frame structure is a time division duplex frame structure of all terminal devices in the first user group, and the first terminal device further includes a processing module, where the transceiver module is further configured to receive third configuration information, where the third configuration information is used to configure a second time division duplex frame structure, and the second time division duplex frame structure is a time division duplex frame structure of the first terminal device; and the processing module is configured to update the first time division duplex frame structure to the second time division duplex frame structure.

In some embodiments, with reference to the third aspect, the transceiver module is further configured to send assistance information, where the assistance information includes at least one of the following: location information of the first terminal device and the first timing advance.

In some embodiments, with reference to the third aspect, the terminal device that uses the first time division duplex frame structure includes all the terminal devices in the plurality of user groups, the plurality of user groups include the first user group to which the first terminal device belongs and the second user group to which a second terminal device belongs, and the transceiver module is further configured to receive fourth configuration information, where the fourth configuration information is used to configure a first polarization direction corresponding to the first terminal device on the first uplink time domain resource in the first time division duplex frame structure, and configure a second polarization direction corresponding to the second terminal device on a first downlink time domain resource in the first time division duplex frame structure, where the first uplink time domain resource overlaps the first downlink time domain resource, and the first polarization direction is different from the second polarization direction.

According to a fourth aspect, a communication apparatus is provided. The communication apparatus is a network device, and the network device includes a transceiver module and a processing module, where the processing module is configured to generate first configuration information, where the first configuration information is used to configure a first time division duplex frame structure; the transceiver module is configured to send the first configuration information; and the transceiver module is further configured to receive uplink data on a first uplink time domain resource in the first time division duplex frame structure, where an interval between adjacent uplink time domain resources in the first time division duplex frame structure is determined based on a largest timing advance and a smallest timing advance in a terminal device that uses the first time division duplex frame structure.

In some embodiments, with reference to the fourth aspect, the interval between the adjacent uplink time domain resources in the first time division duplex frame structure is a difference between the largest timing advance and the smallest timing advance in the terminal device that uses the first time division duplex frame structure.

In some embodiments, with reference to the fourth aspect, the terminal device that uses the first time division duplex frame structure includes all terminal devices in a cell managed by the network device; or the terminal device that uses the first time division duplex frame structure includes all terminal devices in one or more user groups, and the one or more user groups include a first user group to which a first terminal device belongs.

In some embodiments, with reference to the fourth aspect, an interval between adjacent uplink time domain resources corresponding to each user group in the first time division duplex frame structure is determined based on a largest timing advance and a smallest timing advance of the user group.

In some embodiments, with reference to the fourth aspect, a first timing advance is greater than or equal to a smallest timing advance of the first user group and is less than a largest timing advance of the first user group, and the first uplink time domain resource is an uplink time domain resource corresponding to the first user group.

In some embodiments, with reference to the fourth aspect, the first user group is associated with a first bandwidth part, and time domain resources of the first user group in the first bandwidth part have one transmission direction.

In some embodiments, with reference to the fourth aspect, the plurality of user groups further include a second user group, the second user group is associated with a second bandwidth part, and an uplink time domain resource of the first user group in the first bandwidth part is different from an uplink time domain resource of the second user group in the second bandwidth part.

In some embodiments, with reference to the fourth aspect, a guard period in the first time division duplex frame structure is determined based on the largest timing advance of the first user group to which the first terminal device belongs, and the first user group is one of a plurality of user groups in the cell managed by the network device.

In some embodiments, with reference to the fourth aspect, a difference between the largest timing advance and the smallest timing advance of the first user group is less than a difference between a largest timing advance and a smallest timing advance in the cell managed by the network device.

In some embodiments, with reference to the fourth aspect, the transceiver module is further configured to send second configuration information, where the second configuration information is used to configure at least one of the following: the guard period in the first time division duplex frame structure and the interval between the adjacent uplink time domain resources in the first time division duplex frame structure.

In some embodiments, with reference to the fourth aspect, the first time division duplex frame structure is a time division duplex frame structure of all terminal devices in the first user group; the processing module is further configured to generate third configuration information, where the third configuration information is used to configure a second time division duplex frame structure, and the second time division duplex frame structure is a time division duplex frame structure of the first terminal device; and the transceiver module is further configured to send the third configuration information.

In some embodiments, with reference to the fourth aspect, the transceiver module is further configured to receive assistance information, where the assistance information includes at least one of the following: location information of the first terminal device or the timing advance of the first terminal device; and when generating the third configuration information, the processing module is configured to generate the third configuration information based on the assistance information.

In some embodiments, with reference to the fourth aspect, the terminal device that uses the first time division duplex frame structure includes all the terminal devices in the plurality of user groups, and the plurality of user groups include the first user group to which the first terminal device belongs and the second user group to which a second terminal device belongs; and the transceiver module is further configured to send fourth configuration information, where the fourth configuration information is used to configure a first polarization direction corresponding to the first terminal device on the first uplink time domain resource in the first time division duplex frame structure, and configure a second polarization direction corresponding to the second terminal device on a first downlink time domain resource in the first time division duplex frame structure, where the first uplink time domain resource overlaps the first downlink time domain resource, and the first polarization direction is different from the second polarization direction.

According to a fifth aspect, a communication apparatus is provided. The communication apparatus includes a processor. The processor invokes a computer program stored in a memory to implement the method according to any one of the first aspect or the second aspect.

In a possible design, the communication apparatus may be a chip that implements the method in the first aspect or the second aspect or a device that includes the chip.

According to a sixth aspect, a communication apparatus is provided. The communication apparatus includes a logic circuit and an input/output interface, where the logic circuit is configured to read and execute stored instructions, and when the instructions are run, the communication apparatus is enabled to perform the method according to any one of the first aspect or the second aspect.

According to a seventh aspect, a computer-readable storage medium is provided. The computer-readable storage medium stores a computer program, and when the computer program is run, the method according to any one of the first aspect or the second aspect is implemented.

According to an eighth aspect, a computer program product including instructions is provided. When the instructions are executed on a computer, the method according to any one of the first aspect or the second aspect is performed.

According to a ninth aspect, a communication system is provided. The communication system includes one or more of the following: a first terminal device that performs the method according to any implementation of the first aspect, and a network device that performs the method according to any implementation of the second aspect.

### BRIEF DESCRIPTION OF DRAWINGS

The following briefly describes accompanying drawings used for describing embodiments.

FIG. 1 shows a basic architecture of a communication system according to an embodiment of this application;

FIG. 2 shows a basic architecture of a communication system applicable to an embodiment of this application;

FIG. 3 is a diagram of a hardware structure of a communication apparatus applicable to an embodiment of this application;

FIG. 4 is a schematic flowchart of a resource configuration method according to an embodiment of this application;

FIG. 5 is a diagram of adjacent uplink time domain resources corresponding to different user groups according to an embodiment of this application;

FIG. 6 is a diagram of data transmission when different user groups are associated with different bandwidth parts according to an embodiment of this application;

FIG. 7 is a diagram of a first time division duplex frame structure according to an embodiment of this application;

FIG. 8 is a diagram of a description for resolving a technical problem of this solution in Manner 1 according to an embodiment of this application;

FIG. 9 is a diagram of a description for resolving a technical problem of this solution in Manner 2 according to an embodiment of this application;

FIG. 10 is a diagram of a description for resolving a technical problem of this solution in Manner 3 according to an embodiment of this application;

FIG. 11 is a diagram of a structure of a communication apparatus according to an embodiment of this application;

FIG. 12 is a diagram of a structure of a simplified first terminal device according to an embodiment of this application; and

FIG. 13 is a diagram of a structure of a simplified network device according to an embodiment of this application.

### DETAILED DESCRIPTION

The following describes the technical solutions in embodiments of this application with reference to the accompanying drawings in embodiments of this application. The terms “system” and “network” may be used interchangeably in embodiments of this application. “/” represents an “or” relationship between associated objects unless otherwise specified. For example, A/B may represent A or B. The term “and/or” in this application describes only an association relationship for describing associated objects, and represents that three relationships may exist. For example, A and/or B may represent the following three cases: Only A exists, both A and B exist, and only B exists, where A and B each may be singular or plural. In addition, in the descriptions of this application, “a plurality of” means two or more than two unless otherwise specified. “At least one of the following items (pieces)” or a similar expression thereof refers to any combination of these items, including any combination of singular items (pieces) or plural items (pieces). For example, at least one of a, b, or c may represent a, b, c, a and b, a and c, b and c, or a, b, and c, where a, b, and c may be singular or plural. In addition, to clearly describe the technical solutions in embodiments of this application, terms such as “first” and “second” are used in embodiments of this application to distinguish between same items or similar items that have basically same network elements or purposes. A person skilled in the art may understand that the terms such as “first” and “second” do not limit a quantity and an execution sequence, and the terms such as “first” and “second” do not indicate a definite difference.

Reference to “an embodiment”, “some embodiments”, or the like described in embodiments of this application indicates that one or more embodiments of this application include a specific feature, structure, or characteristic described with reference to embodiments. Therefore, statements such as “in one embodiment”, “in some embodiments”, “in some other embodiments”, and “in still some other embodiments” that appear at different places in this specification do not necessarily refer to a same embodiment, but mean “one or more but not all embodiments”, unless otherwise specially emphasized in another manner. The terms “include”, “have”, and their variants all mean “include but are not limited to”, unless otherwise specifically emphasized in another manner.

Objectives, technical solutions, and beneficial effect of this application are further described in detail in the following specific implementations. It should be understood that the following descriptions are merely specific implementations of this application, but are not intended to limit the protection scope of this application. Any modification, equivalent replacement, or improvement made based on technical solutions of this application shall fall within the protection scope of this application.

In embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

The following explains and describes some nouns (or communication terms) in this application. It may be understood that when the following nouns are used in other parts of this application, no explanation or description is provided subsequently.

### 1. Timing Advance (Timing Advance, TA)

From the perspective of a terminal device side, the TA is essentially a negative offset (negative offset) between start time at which a downlink subframe is received and start time at which an uplink subframe is transmitted.

In a communication system, there is a delay in signal transmission in space. For example, some terminal devices are moving in a direction away from a network device. A terminal device farther away from the network device receives a downlink signal from the network device later, and a sent uplink signal also arrives at the network device later. For another example, some terminal devices are moving in a direction close to a network device. A terminal device closer to the network device receives a downlink signal from the network device earlier, and a sent uplink signal also arrives at the network device earlier. Consequently, different delays cause interference between uplink signals sent by the terminal devices. Therefore, the network device needs to monitor time at which an uplink signal sent by the terminal device arrives at the network device, and send an instruction to the terminal device on a downlink channel, to indicate a timing advance, namely, TA, of the uplink signal sent by the terminal device relative to a downlink signal reference point.

By properly controlling a TA of each terminal device, the network device may control time at which uplink signals from different terminal devices arrive at the network device. Because of a larger transmission delay, a terminal device farther away from the network device needs to send uplink data earlier than a terminal device closer to the network device. Therefore, a TA of the terminal device farther away from the network device is greater than a TA of the terminal device closer to the network device.

### 2. Time Division Duplex Frame Structure

In the time division duplex frame structure, one radio frame may be used to transmit both an uplink signal and a downlink signal. In other words, the time division duplex frame structure may include at least one of the following: an uplink time domain resource, a downlink time domain resource, and a flexible time domain resource. The flexible time domain resource may be dynamically adjusted to the uplink time domain resource or the downlink time domain resource.

The time domain resource may include resources at different time granularities such as a subframe, a slot, a mini-slot, or a symbol.

### 3. Bandwidth Part (Bandwidth Part, BWP)

The BWP is defined as a combination of a plurality of contiguous resource blocks (resource blocks, RBs) in one carrier. Different BWPs are on different frequency bands.

### 4. Guard Period

The guard period is generally an interval at which a downlink time domain resource is switched to an uplink time domain resource. The guard period may separate the uplink time domain resource from the downlink time domain resource, and the network device does not receive or send data in the guard period.

### 5. Polarization Direction

The polarization direction may be a linear polarization direction, a circular polarization direction, or an elliptical polarization direction. The linear polarization direction may include a horizontal polarization direction or a vertical polarization direction, and the circular polarization direction may include a left-hand circular polarization direction or a right-hand circular polarization direction.

It should be understood that the technical solutions in embodiments of this application may be applied to long term evolution (long term evolution, LTE), a 5th generation mobile communication technology (5th generation mobile network, 5G), and the like. The technical solutions in embodiments of this application may be further applied to another future communication system, for example, a 6G communication system. In the future communication system, a same function may be maintained, but a name may be changed.

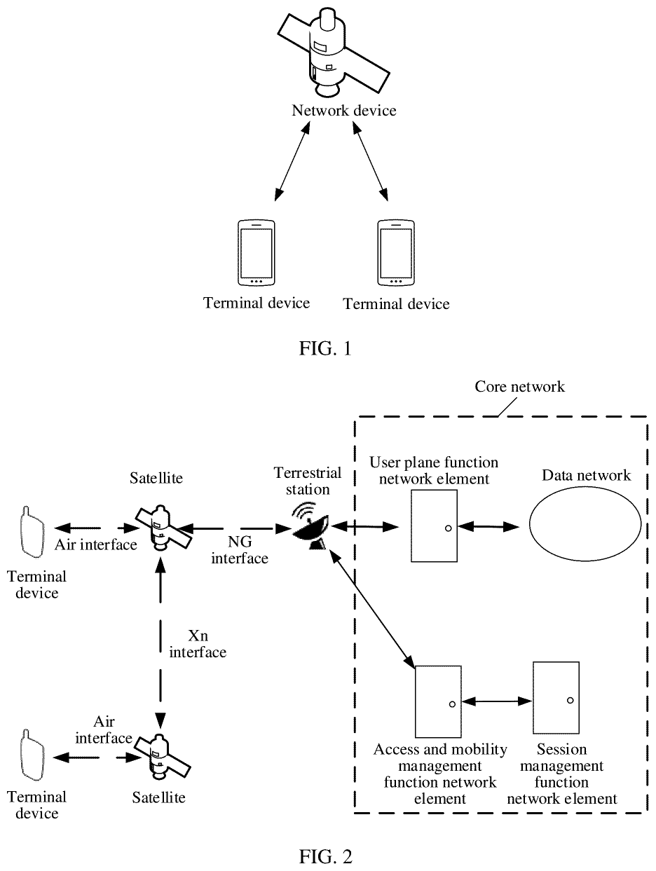

FIG. 1 shows a basic architecture of a communication system according to an embodiment of this application. As shown in FIG. 1, the communication system may include at least one terminal device and a network device that communicates with each terminal device. For example, a first terminal device communicates with the network device, and a second terminal device communicates with the network device. FIG. 1 is merely a diagram, and does not constitute a limitation on an applicable scenario of the technical solutions provided in this application.

The terminal device is an entity that is on a user side and that is configured to send and/or receive a signal. The terminal device is configured to provide one or more of a voice service and a data connectivity service for a user. Specifically, the terminal device may be user equipment (user equipment, UE), an access terminal, a subscriber unit, a subscriber station, a mobile station, a remote station, a remote terminal, a mobile device, a terminal, a wireless communication device, a user agent, or a user apparatus. The terminal device may alternatively be an uncrewed aerial vehicle, an internet of things (internet of things, IoT) device, a station (station, ST) in a WLAN, a cellular phone (cellular phone), a smartphone (smartphone), a cordless phone, a wireless data card, a tablet computer, a session initiation protocol (session initiation protocol, SIP) phone, a wireless local loop (wireless local loop, WLL) station, a personal digital assistant (personal digital assistant, PDA) device, a laptop computer (laptop computer), a machine type communication (machine type communication, MTC) terminal, a handheld device with a wireless communication function, a computing device or another processing device connected to a wireless modem, a vehicle-mounted device, a wearable device (also referred to as a wearable intelligent device), a virtual reality (virtual reality, VR) terminal, an augmented reality (augmented reality, AR) terminal, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), or the like. The terminal device may alternatively be a device-to-device (device-to-device, D2D) device, for example, an electricity meter or a water meter. A type of the terminal device is not limited in this embodiment of this application.

The network device may provide a wireless access service for the terminal device, schedule a radio resource for the accessed terminal device, and provide a reliable wireless transmission protocol, a data encryption protocol, and the like. The network device may be a base station used for wireless communication, such as an artificial earth satellite and a high-altitude aircraft, for example, a medium earth orbit (medium earth orbit, MEO) satellite or a low earth orbit (low earth orbit, LEO) satellite of a non-geostationary earth orbit (non-geostationary earth orbit, NGEO), a high-altitude communication platform (High-Altitude Platform Station, HAPS), an evolved NodeB (evolved NodeB, eNB), or a 5G base station (gNB).

The following describes a basic architecture of a communication system applicable to which this application is applicable by using an example in which the network device is a satellite. Specifically, as shown in FIG. 2, the communication system includes at least one of the following: a terminal device, a satellite, a terrestrial station, and a core network.

The terminal device may access a network through an air interface, and the air interface is a radio link between the terminal device and a base station. The air interface may be various types of air interfaces, for example, a 5G air interface.

In FIG. 2, the base station is deployed on the satellite, and is connected to a terrestrial core network through a radio link, for example, an NG interface. The NG interface is an interface between the base station and the core network, and mainly exchanges non-access stratum (non-access stratum, NAS) signaling of the core network and service data of a user. In addition, a radio link may exist between satellites, and signaling exchange and user data transmission between satellites are completed by using an Xn interface. The Xn interface is an interface between base stations, and is mainly configured for signaling exchange such as handover.

The terrestrial station is responsible for forwarding signaling and service data between the satellite and the core network.

The core network (core network, CN) is mainly used for user access control, charging, mobility management, session management, user security authentication, and the like. With reference to FIG. 2, it can be learned that the core network may include a user plane function (user plane function, UPF) network element, an access and mobility management function (access and mobility management function, AMF) network element, a session management function (session management function, SMF) network element, a data network (data network, DN), and the like. The user plane function network element serves as an interface to the data network, and completes user plane data forwarding, session-based/flow level-based charging statistics, bandwidth limitation, and other functions. The access and mobility management function network element performs mobility management, access authentication/authorization, and other functions. The session management function network element performs session management, user plane function network element selection, and internet protocol (internet protocol, IP) address allocation for the terminal, and other functions. The data network is a network located outside an operator network. The operator network may access a plurality of data networks, and a plurality of services may be deployed on the data network, to provide services such as a data service and/or a voice service for the terminal device.

In some embodiments, the network device, the terminal device, and the like in FIG. 1 may be separately implemented by one device, or may be jointly implemented by a plurality of devices, or may be a functional module in one device. This is not specifically limited in this embodiment of this application. It may be understood that the foregoing functions may be network elements in a hardware device, or may be software functions running on dedicated hardware, or may be virtualization functions instantiated on a platform (for example, a cloud platform).

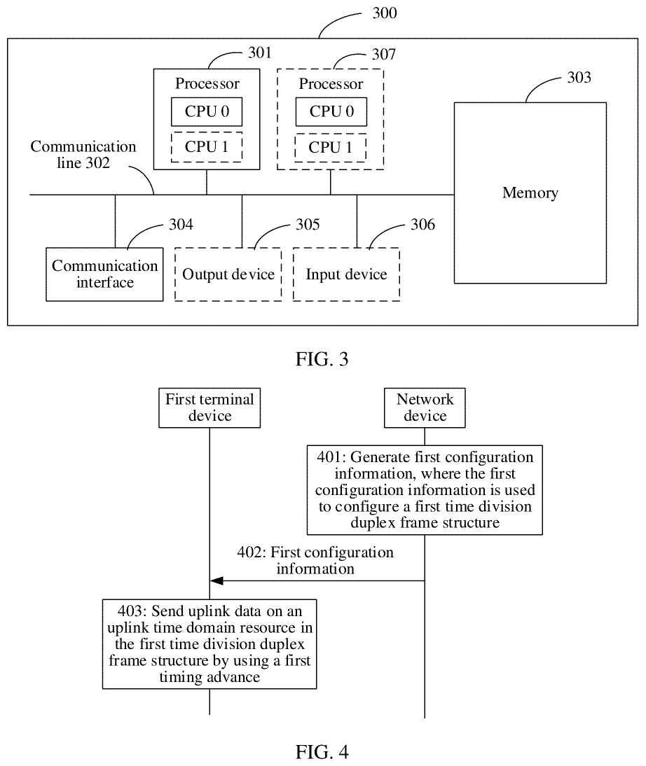

For example, each device in FIG. 1 may be implemented by a communication apparatus 300 in FIG. 3. FIG. 3 is a diagram of a hardware structure of a communication apparatus applicable to an embodiment of this application. The communication apparatus 300 includes at least one processor 301, a communication line 302, a memory 303, and at least one communication interface 304.

The processor 301 may be a general-purpose central processing unit (central processing unit, CPU), a microprocessor, an application-specific integrated circuit (application-specific integrated circuit, ASIC), or one or more integrated circuits configured to control program execution of the solutions of this application.

The communication line 302 may include a path for transmitting information between the foregoing components.

The communication interface 304 is any transceiver-type apparatus (such as an antenna), and is configured to communicate with another device or a communication network, for example, the Ethernet, a RAN, or a wireless local area network (wireless local area network, WLAN).

The memory 303 may be a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (electrically erasable programmable read-only memory, EEPROM), a compact disc read-only memory (compact disc read-only memory, CD-ROM) or another compact disc storage, an optical disc storage (including a compressed optical disc, a laser disc, an optical disc, a digital versatile disc, a Blu-ray optical disc, and the like), a magnetic disk storage medium or another magnetic storage device, or any other medium that can be used to carry or store expected program code in a form of an instruction or a data structure and that can be accessed by a computer. However, this is not limited thereto. The memory may exist independently, and is connected to the processor through the communication line 302. The memory may alternatively be integrated with the processor. The memory provided in this embodiment of this application may be usually non-volatile. The memory 303 is configured to store computer-executable instructions for performing the solutions in this application, and the processor 301 controls execution. The processor 301 is configured to execute the computer-executable instructions stored in the memory 303, to implement the method provided in the following embodiments of this application.

In some embodiments, the computer-executable instructions in this embodiment of this application may also be referred to as application program code. This is not specifically limited in this embodiment of this application.

In a possible implementation, the processor 301 may include one or more CPUs, for example, a CPU 0 and a CPU 1 in FIG. 3.

In a possible implementation, the communication apparatus 300 may include a plurality of processors, for example, the processor 301 and a processor 307 in FIG. 3. Each of the processors may be a single-core (single-CPU) processor, or may be a multi-core (multi-CPU) processor. The processor herein may refer to one or more devices, circuits, and/or processing cores configured to process data (for example, computer program instructions).

In a possible implementation, the communication apparatus 300 may further include an output device 305 and an input device 306. The output device 305 communicates with the processor 301, and may display information in a plurality of manners. For example, the output device 305 may be a liquid crystal display (liquid crystal display, LCD), a light emitting diode (light emitting diode, LED) display device, a cathode ray tube (cathode ray tube, CRT) display device, or a projector (projector). The input device 306 communicates with the processor 301, and may receive an input of a user in a plurality of manners. For example, the input device 306 may be a mouse, a keyboard, a touchscreen device, or a sensor device.

The communication apparatus 300 may be a general-purpose device or a dedicated device. During specific implementation, the communication apparatus 300 may be a portable computer, a network server, a palmtop computer (personal digital assistant, PDA), a mobile phone, a tablet computer, a wireless terminal device, an embedded device, or a device having a structure similar to that in FIG. 3. A type of the communication apparatus 300 is not limited in this embodiment of this application.

After the communication apparatus is powered on, the processor 301 may read a software program in the memory 303, interpret and execute instructions of the software program, and process data of the software program. When data needs to be sent wirelessly, the processor 301 performs baseband processing on the to-be-sent data, and then outputs a baseband signal to a radio frequency circuit. The radio frequency circuit performs radio frequency processing on the baseband signal, and then sends a radio frequency signal to the outside in a form of an electromagnetic wave through the antenna. When data is sent to the communication apparatus, the radio frequency circuit receives a radio frequency signal through the antenna, converts the radio frequency signal into a baseband signal, and outputs the baseband signal to the processor 301. The processor 301 converts the baseband signal into data, and processes the data.

In another implementation, the radio frequency circuit and the antenna may be disposed independent of the processor that performs baseband processing. For example, in a distributed scenario, the radio frequency circuit and the antenna may be remotely disposed independent of the communication apparatus.

The following describes the technical solutions provided in embodiments of this application with reference to the accompanying drawings.

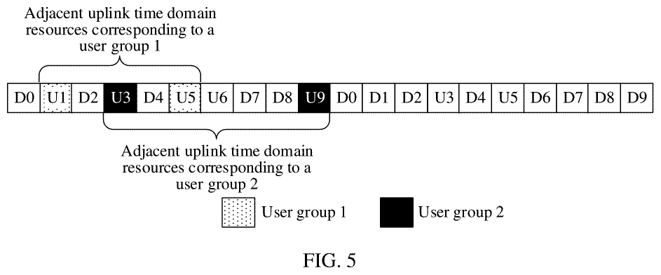

FIG. 4 is a schematic flowchart of a resource configuration method according to an embodiment of this application. As shown in FIG. 4, the method includes but is not limited to the following steps.

401: A network device generates first configuration information, where the first configuration information is used to configure a first time division duplex frame structure.

The first configuration information may be carried in a system information block (system information block, SIB), a master information block (master information block, MIB), radio resource control (radio resource control, RRC) signaling, downlink control information (downlink control information, DCI), or a media access control (media access control, MAC) control element (control element, CE).

For a time domain resource included in the first time division duplex frame structure, refer to the foregoing related descriptions. Details are not described herein again.

402: A first terminal device receives the first configuration information.

Correspondingly, the network device sends the first configuration information.

In this application, receiving may be understood as direct receiving or relay receiving, and correspondingly, sending may be understood as direct sending or relay sending. For example, in a possible implementation, in a case of direct receiving, step 402 may be understood as: The first terminal device receives the first configuration information from the network device, and correspondingly, the network device sends the first configuration information to the first terminal device. In another possible implementation, in a case of relay receiving, step 402 may be understood as: The first terminal device receives the first configuration information from the network device via a relay device, and correspondingly, the network device sends the first configuration information to the first terminal device via the relay device. The relay device may be, for example, a relay base station, for example, a micro base station. Alternatively, the relay device may be a relay terminal, for example, an idle terminal. Alternatively, the relay device may be a relay transmission reception point (TRP), for example, a network entity such as customer premise equipment (customer premise equipment, CPE), a relay transceiver, or a relay agent.

403: The first terminal device sends uplink data on an uplink time domain resource in the first time division duplex frame structure by using a first timing advance.

Correspondingly, the network device receives the uplink data on the uplink time domain resource in the first time division duplex frame structure.

Step 403 may be understood as: The first terminal device sends the uplink data to the network device on the uplink time domain resource in the first time division duplex frame structure by using the first timing advance. Correspondingly, the network device receives the uplink data from the first terminal device on the uplink time domain resource in the first time division duplex frame structure. Alternatively, step 403 may be understood as: The first terminal device sends the uplink data to the network device on the uplink time domain resource in the first time division duplex frame structure by using the first timing advance via the relay device. Correspondingly, the network device receives the uplink data from the first terminal device on the uplink time domain resource in the first time division duplex frame structure via the relay device.

In some embodiments, with reference to step 401 to step 403, to resolve a problem of a conflict between reception of the uplink data and sending of downlink data when a TDD communication manner is used, any one or more of the following manners may be used in this application. This is not limited herein.

Manner 1: An interval between adjacent uplink time domain resources in the first time division duplex frame structure is determined based on a largest timing advance and a smallest timing advance in a terminal device that uses the first time division duplex frame structure. For example, that an interval between adjacent uplink time domain resources in the first time division duplex frame structure is determined based on a largest timing advance and a smallest timing advance in a terminal device that uses the first time division duplex frame structure may be understood as: The interval between the adjacent uplink time domain resources in the first time division duplex frame structure is a difference between the largest timing advance and the smallest timing advance in the terminal device that uses the first time division duplex frame structure; or the interval between the adjacent uplink time domain resources in the first time division duplex frame structure is greater than the difference between the largest timing advance and the smallest timing advance in the terminal device that uses the first time division duplex frame structure.

Manner 2: A guard period in the first time division duplex frame structure is determined based on a largest timing advance of a first user group to which the first terminal device belongs, and the first user group is one of a plurality of user groups in a cell managed by the network device. In other words, a quantity of terminal devices in the first user group is less than a quantity of terminal devices in the cell managed by the network device.

Manner 3: The terminal device that uses the first time division duplex frame structure includes all terminal devices in a plurality of user groups, and the plurality of user groups include a first user group to which the first terminal device belongs and a second user group to which a second terminal device belongs. The first terminal device receives fourth configuration information, and correspondingly, the network device sends the fourth configuration information. The fourth configuration information is used to configure a first polarization direction corresponding to the first terminal device on the first uplink time domain resource in the first time division duplex frame structure, and configure a second polarization direction corresponding to the second terminal device on a first downlink time domain resource in the first time division duplex frame structure, where the first uplink time domain resource overlaps the first downlink time domain resource, and the first polarization direction is different from the second polarization direction. That the first uplink time domain resource overlaps the first downlink time domain resource may be understood as: The first uplink time domain resource completely overlaps the first downlink time domain resource. The fourth configuration information may be carried in the SIB, the MIB, the RRC signaling, the DCI, or the MAC CE. In a possible implementation, the first configuration information and the fourth configuration information may be carried in a same message, or the first configuration information and the fourth configuration information may be carried in different messages. It should be understood that when the first configuration information and the fourth configuration information are carried in different messages, the first terminal device may receive the fourth configuration information before performing step 402.

With reference to step 401 to step 403 and Manner 1, to better understand this solution, the following describes related content of Manner 1.

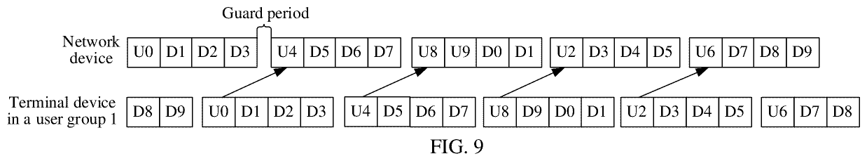

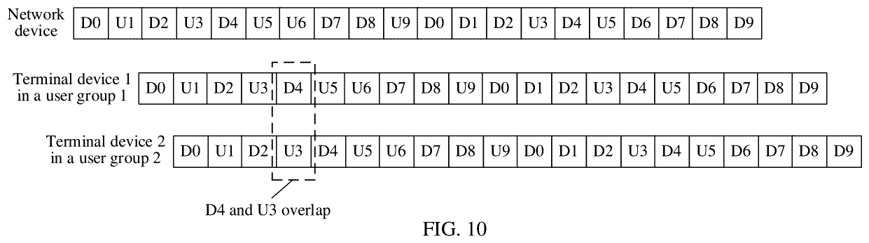

In Manner 1, the terminal device that uses the first time division duplex frame structure may include all terminal devices in a cell managed by the network device; or the terminal device that uses the first time division duplex frame structure may include all terminal devices in one or more user groups, and the one or more user groups include a first user group to which the first terminal device belongs. In a possible implementation, one user group may include some or all terminal devices within coverage of one or more beams of the network device. It should be noted that, when the terminal device that uses the first time division duplex frame structure may include all the terminal devices in the one or more user groups, the adjacent uplink time domain resources in the first time division duplex frame structure may be understood as adjacent uplink time domain resources corresponding to each user group in the first time division duplex frame structure. For example, FIG. 5 is a diagram of adjacent uplink time domain resources corresponding to different user groups according to an embodiment of this application. In FIG. 5 to FIG. 7, FIG. 9, and FIG. 10, U represents an uplink time domain resource, D represents a downlink time domain resource, and a number following U and D represents a number of a time domain resource. For example, U0 represents an uplink time domain resource numbered 0. In FIG. 5, the network device configures a same time division duplex frame structure for a user group 1 and a user group 2. In other words, the time division duplex frame structure is a frame structure shared by the user group 1 and the user group 2. With reference to FIG. 5, it can be learned that adjacent uplink time domain resources corresponding to the user group 1 include U1 and U5, and adjacent uplink time domain resources corresponding to the user group 2 include U3 and U9. It can be learned that, in a case in which the first time division duplex frame structure is a cell-level or user group-level frame structure, when uplink data arrives at the network device, a time domain resource that can be used by the network device is an uplink time domain resource. Therefore, the network device can receive the uplink data on the uplink time domain resource, to resolve a problem of a conflict between the reception of the uplink data and sending of downlink data when the TDD communication manner is used.

In some embodiments, in Manner 1, when the terminal device that uses the first time division duplex frame structure includes all the terminal devices in the one or more user groups, an interval between adjacent uplink time domain resources corresponding to each user group in the first time division duplex frame structure is determined based on a largest timing advance and a smallest timing advance of the user group. To be specific, the interval between the adjacent uplink time domain resources corresponding to each user group in the first time division duplex frame structure may be greater than or equal to a difference between the largest timing advance and the smallest timing advance of the user group. For example, the terminal device that uses the first time division duplex frame structure includes all terminal devices in the first user group and a second user group, the first user group is a user group to which the first terminal device belongs, and the second user group is a user group to which a second terminal device belongs. An interval between adjacent uplink time domain resources corresponding to the first user group in the first time division duplex frame structure is determined based on a largest timing advance and a smallest timing advance of the first user group, and an interval between adjacent uplink time domain resources corresponding to the second user group in the first time division duplex frame structure is determined based on a largest timing advance and a smallest timing advance of the second user group. In other words, the interval between the adjacent uplink time domain resources corresponding to the first user group in the first time division duplex frame structure may be greater than or equal to a difference between the largest timing advance and the smallest timing advance of the first user group, and the interval between the adjacent uplink time domain resources corresponding to the second user group in the first time division duplex frame structure may be greater than or equal to a difference between the largest timing advance and the smallest timing advance of the second user group. It can be learned that, intervals between adjacent uplink time domain resources corresponding to different user groups are different, and when uplink data of different user groups arrives at the network device, a time domain resource that can be used by the network device is an uplink time domain resource. Therefore, the network device can receive the uplink data on the uplink time domain resource, to resolve a problem of a conflict between the reception of the uplink data corresponding to different user groups and sending of downlink data when the TDD communication manner is used.

It should be understood that, in Manner 1, because the interval between the adjacent uplink time domain resources corresponding to each user group in the first time division duplex frame structure is determined based on the largest timing advance and the smallest timing advance of the user group, any terminal device that uses the first time division duplex frame structure needs to determine an uplink time domain resource that can be used in the first time division duplex frame structure. For example, the first timing advance of the first terminal device may be greater than or equal to the smallest timing advance of the first user group, and the first timing advance is less than the largest timing advance of the first user group. Alternatively, the first timing advance may be greater than the smallest timing advance of the first user group, and the first timing advance is less than or equal to the largest timing advance of the first user group. Because the interval between the adjacent uplink time domain resources corresponding to the first user group is determined based on the largest timing advance and the smallest timing advance of the first user group, the first terminal device may determine that the uplink time domain resource corresponding to the first user group is a time domain resource that can be used by the first terminal device, that is, the first uplink time domain resource in step 403 is the uplink time domain resource corresponding to the first user group. In other words, the first uplink time domain resource is a time domain resource that the first terminal device is allowed to use. It should be noted that a terminal device in any user group may determine, based on a timing advance of the terminal device, an uplink time domain resource that can be used in the first time division duplex frame structure. In addition, the terminal device in any user group does not send uplink data on an uplink time domain resource that cannot be used in the first time division duplex frame structure, to avoid a signal interference problem. For example, an uplink time domain resource that cannot be used by a terminal device 1 completely overlaps a downlink time domain resource of a terminal device 2. Because the terminal device 1 sends uplink data only on an uplink time domain resource that can be used, the uplink data of the terminal device 1 does not conflict with downlink data of the terminal device 2.

In some embodiments, in Manner 1, when the terminal device that uses the first time division duplex frame structure includes all the terminal devices in the one or more user groups, the one or more user groups include a first user group to which the first terminal device belongs, the first user group is associated with a first bandwidth part, and time domain resources of the first user group in the first bandwidth part have one transmission direction. In other words, the first user group has only an uplink time domain resource in the first bandwidth part, or the first user group has only a downlink time domain resource in the first bandwidth part. Similarly, a user group other than the first user group in the plurality of user groups may be associated with a bandwidth part other than the first bandwidth part, and time domain resources of the user group in the bandwidth part have one transmission direction. For example, the plurality of user groups further include a second user group to which a second terminal device belongs, the second user group is associated with a second bandwidth part, and time domain resources of the second user group in the second bandwidth part have one transmission direction. In other words, the second user group has only an uplink time domain resource in the second bandwidth part, or the second user group has only a downlink time domain resource in the second bandwidth part. The first bandwidth part and the second bandwidth part are located in different frequency bands. When the first user group has only the uplink time domain resource in the first bandwidth part, and the second user group has only the uplink time domain resource in the second bandwidth part, the uplink time domain resource of the first user group in the first bandwidth part is different from the uplink time domain resource of the second user group in the second bandwidth part. It should be understood that, bandwidth parts associated with different user groups are located in different frequency bands, and time domain resources in a bandwidth part associated with a same user group have one transmission direction. Therefore, there is no signal interference problem when terminal devices in different user groups simultaneously transmit uplink data and/or send downlink data on different frequency bands. In addition, terminal devices in a same user group can transmit only uplink data or downlink data on a same frequency band. Therefore, the terminal devices in the same user group have no signal interference problem.

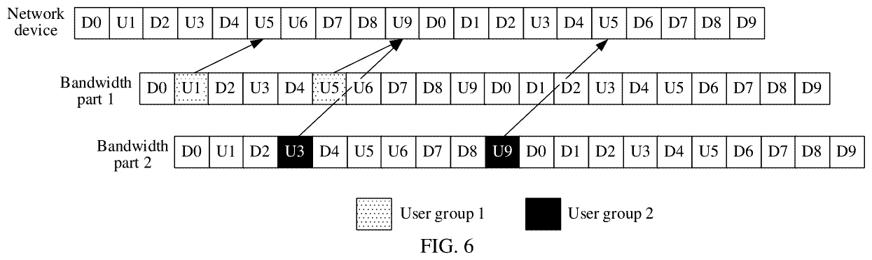

For example, FIG. 6 is a diagram of data transmission when different user groups are associated with different bandwidth parts according to an embodiment of this application. As shown in FIG. 6, the network device configures a same time division duplex frame structure for the user group 1 and the user group 2. In other words, the time division duplex frame structure is a frame structure shared by the user group 1 and the user group 2. A bandwidth part 1 and a bandwidth part 2 are on different frequency bands. The user group 1 has only uplink time domain resources in the bandwidth part 1, for example, U1 and U5, and the user group 2 has only uplink time domain resources in the bandwidth part 2, for example, U3 and U9. When any terminal device in the user group 1 or the user group 2 sends uplink data on an uplink time domain resource in the time division duplex frame structure, uplink data of a terminal device in the user group 1 is on one frequency band, and uplink data of a terminal device in the user group 2 is on another frequency band. Therefore, there is no signal interference between uplink data of terminal devices in different user groups.

With reference to step 401 to step 403 and Manner 2, to better understand this solution, the following describes related content of Manner 2.

In Manner 2, the guard period in the first time division duplex frame structure may be a cyclic prefix (cyclic prefix, CP), or the guard period in the first time division duplex frame structure may be empty.

In some embodiments, in Manner 2, a difference between the largest timing advance and a smallest timing advance of the first user group is less than a difference between a largest timing advance and a smallest timing advance in the cell managed by the network device. It can be learned that, because the difference between the largest timing advance and the smallest timing advance of the first user group is less than the difference between the largest timing advance and the smallest timing advance in the cell managed by the network device, and the guard period in the first time division duplex frame structure is determined based on the largest timing advance of the first user group to which the first terminal device belongs, the guard period is less than the largest timing advance in the cell managed by the network device. Because data cannot be received or sent in the guard period, when the guard period is less than the largest timing advance of the cell managed by the network device, resource utilization can be improved.

In some embodiments, in Manner 2, when the first time division duplex frame structure is a time division duplex frame structure of all terminal devices in the first user group, the method may further include: The first terminal device receives third configuration information; and correspondingly, the network device sends the third configuration information, where the third configuration information is used to configure a second time division duplex frame structure, and the second time division duplex frame structure is a time division duplex frame structure of the first terminal device. The first terminal device updates the first time division duplex frame structure to the second time division duplex frame structure. A guard period in the second time division duplex frame structure is determined based on the first timing advance. For a time domain resource included in the second time division duplex frame structure, refer to the foregoing related descriptions. Details are not described herein again.

It may be understood that, before the network device sends the third configuration information, the network device may further receive assistance information; and correspondingly. the first terminal device may further send the assistance information to the network device. For example. the network device may receive the assistance information from the first terminal device; and correspondingly, the first terminal device may send the assistance information to the network device. Alternatively, the network device may receive the assistance information from the first terminal device via a relay device; and correspondingly, the first terminal device may send the assistance information to the network device via the relay device. The assistance information includes at least one of the following: location information of the first terminal device and the first timing advance. After the network device obtains the assistance information, the network device may generate the third configuration information based on the assistance information. For example, when the assistance information is the location information of the first terminal device, the network device may determine the first timing advance based on the location information of the first terminal device, and generate the third configuration information based on the first timing advance. When the assistance information is the first timing advance, the network device may generate the third configuration information based on the first timing advance.

That the first terminal device receives the third configuration information may be understood as: The first terminal device receives the third configuration information from the network device, and correspondingly, the network device sends the third configuration information to the first terminal device. Alternatively, that the first terminal device receives the third configuration information may be understood as: The first terminal device receives the third configuration information from the network device via a relay device, and correspondingly, the network device sends the third configuration information to the first terminal device via the relay device.

In a possible implementation, the third configuration information may be carried in the SIB, the MIB, the RRC signaling, the DCI, or the MAC CE.

It can be learned that, when the first time division duplex frame structure is a user group-level frame structure, the first terminal device may further receive the third configuration information used to configure the second time division duplex frame structure, to update the user group-level frame structure to a user-level time division duplex frame structure, so that the first terminal device can send and receive data by using the user-level time division duplex frame structure, and a delay is reduced.

In some embodiments, in Manner 1, the interval between the adjacent uplink time domain resources in the first time division duplex frame structure may be determined by the first terminal device, or the interval between the adjacent uplink time domain resources in the first time division duplex frame structure may be configured by the network device. Similarly, in Manner 2, the guard period in the first time division duplex frame structure may be determined by the first terminal device, or the guard period in the first time division duplex frame structure may be configured by the network device. The network device may implement configuration of the time domain resource in the first time division duplex frame structure in a form of different combinations such as broadcast, semi-static configuration, and dynamic configuration. In the dynamic configuration, updating or changing may be performed every subframe or slot, or every several subframes or slots (for example, using dynamic signaling, such as DCI), and in the semi-static configuration, updating or changing may be performed every several frames, every several seconds, or only when needed.

For example, when the interval between the adjacent uplink time domain resources in the first time division duplex frame structure may be determined by the first terminal device, that the first configuration information is used to configure the first time division duplex frame structure may be understood as: The first configuration information is only used to configure a location of the uplink time domain resource in the first time division duplex frame structure. After receiving the first configuration information, the first terminal device may determine the interval between the adjacent uplink time domain resources in the first time division duplex frame structure based on the location of the uplink time domain resource in the first time division duplex frame structure. Alternatively, that the first configuration information is used to configure the first time division duplex frame structure may be understood as: The first configuration information is only used to configure a location of a downlink time domain resource in the first time division duplex frame structure, and another location in the first time division duplex frame structure is an uplink time domain resource. After receiving the first configuration information, the first terminal device may learn, based on the location of the downlink time domain resource in the first time division duplex frame structure, that the another location in the first time division duplex frame structure is the uplink time domain resource, and may determine the interval between the adjacent uplink time domain resources in the first time division duplex frame structure. Alternatively, that the first configuration information is used to configure the first time division duplex frame structure may be understood as: The first configuration information is used to configure locations of some uplink time domain resources in the first time division duplex frame structure and an interval between adjacent uplink time domain resources in the some uplink time domain resources. After receiving the first configuration information, the terminal device may not only determine the interval between the adjacent uplink time domain resources in the first time division duplex frame structure, but also determine, based on the locations of the some uplink time domain resources in the first time division duplex frame structure and the interval between the adjacent uplink time domain resources in the some uplink time domain resources, an allocation status of a remaining uplink time domain resource in the first time division duplex frame structure.

For another example, the first configuration information is sent in a broadcast manner, the first configuration information is used to configure locations of some uplink time domain resources in the first time division duplex frame structure, and the network device may further dynamically configure a location of another uplink time domain resource in the first time division duplex frame structure. Alternatively, before step 401, all time domain resources that are in the first time division duplex frame structure and that are obtained by the first terminal device are downlink time domain resources, and the downlink time domain resource may be configured by using semi-persistent scheduling (semi-persistent scheduling, SPS). Then, the network device changes some downlink time domain resources in the first time division duplex frame structure to uplink time domain resources by using dynamic configuration. In other words, the first configuration information is carried in the DCI. It should be understood that in these cases, the first terminal device may determine the interval between the adjacent uplink time domain resources in the first time division duplex frame structure.

For another example, the network device may configure a plurality of time division duplex frame structures, and the first time division duplex frame structure is one of the plurality of time division duplex frame structures. To be specific, the first configuration information is further used to configure a time division duplex frame structure other than the first time division duplex frame structure in the plurality of time division duplex frame structures. The network device may indicate, by using an index, that a time division duplex frame structure used by the first terminal device is the first time division duplex frame structure. Alternatively, the network device may establish an association relationship between a time division duplex frame structure and an index of a reference signal, or establish an association relationship between a time division duplex frame structure and a resource index, and notify the first terminal device of the association relationship, so that the first terminal device learns, based on the association relationship, that the time division duplex frame structure used by the first terminal device is the first time division duplex frame structure. The resource index may be, for example, an index number of a synchronization signal block (synchronization signal block, SS block or SSB), an index number of a beam, or an index number of a reference signal resource.

In some embodiments, when the interval between the adjacent uplink time domain resources in the first time division duplex frame structure is configured by the network device, and the guard period in the first time division duplex frame structure is also configured by the network device, the method may include: The first terminal device receives second configuration information; and correspondingly. the network device sends the second configuration information. For example, the first terminal device receives the second configuration information from the network device, and correspondingly, the network device sends the second configuration information to the first terminal device. Alternatively, the first terminal device receives the second configuration information from the network device via a relay device, and correspondingly, the network device sends the second configuration information to the first terminal device via the relay device. The second configuration information is used to configure at least one of the following: the guard period in the first time division duplex frame structure and the interval between the adjacent uplink time domain resources in the first time division duplex frame structure. The second configuration information may be carried in the SIB, the MIB, the RRC signaling, the DCI, or the MAC CE. In a possible implementation, the first configuration information and the second configuration information may be carried in a same message, or the first configuration information and the second configuration information may be carried in different messages.

When the second configuration information is used to configure the guard period in the first time division duplex frame structure, the first configuration information and the second configuration information may be carried in the RRC signaling. To be specific, the uplink time domain resource in the first time division duplex frame structure, the guard period in the first time division duplex frame structure, the downlink time domain resource in the first time division duplex frame structure, and a flexible time domain resource in the first time division duplex frame structure may be configured by using an RRC message. The network device may further configure, by using the DCI or other signaling, some flexible time domain resources in the first time division duplex frame structure as uplink time domain resources or downlink time domain resources. The network device may consider by default that the guard period is before the uplink time domain resource, or consider by default that the guard period is after the downlink time domain resource.

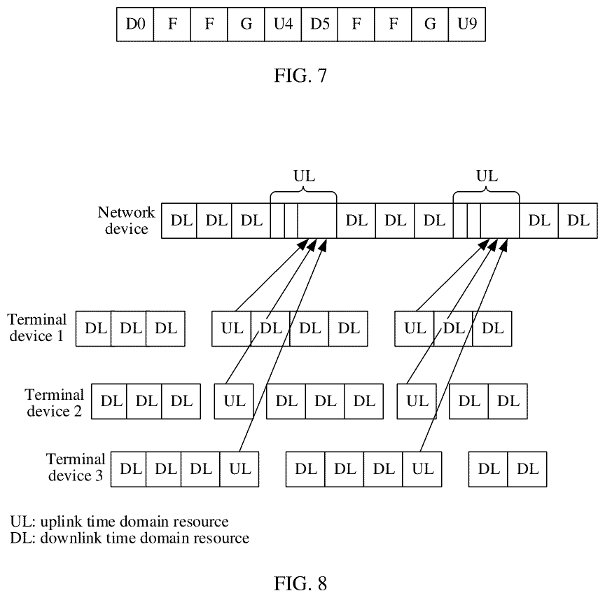

For example, FIG. 7 is a diagram of a first time division duplex frame structure according to an embodiment of this application. In FIG. 7, F represents a flexible time domain resource, and G represents a guard period. It may be understood that the network device may further configure some flexible time domain resources in the first time division duplex frame structure as uplink time domain resources or downlink time domain resources by using DCI or other signaling.

In addition, when the second configuration information is used to configure the guard period in the first time division duplex frame structure, in a possible implementation, a length of the guard period in the first time division duplex frame structure may be a resource combination of time domain resources with a same granularity size, for example, a plurality of symbols or a plurality of subframes. Alternatively, a length of the guard period in the first time division duplex frame structure may be a resource combination of time domain resources of different granularities such as a symbol and a subframe.

It can be learned that, the guard period in the first time division duplex frame structure and/or the interval between the adjacent uplink time domain resources in the first time division duplex frame structure may be configured by the network device. This avoids a process in which the first terminal device determines the guard period in the first time division duplex frame structure and/or the interval between the adjacent uplink time domain resources in the first time division duplex frame structure, so that energy consumption is reduced.

With reference to step 401 to step 403 and Manner 3, to better understand this solution, the following describes related content of Manner 3.

In Manner 3, the first polarization direction may be a left-hand circular polarization direction, and the second polarization direction may be a right-hand circular polarization direction; or the first polarization direction may be a right-hand circular polarization direction, and the second polarization direction may be a left-hand circular polarization direction; or the first polarization direction may be a left-hand circular polarization direction, and the second polarization direction may be an elliptical polarization direction; or the first polarization direction may be an elliptical polarization direction, and the second polarization direction may be a left-hand circular polarization direction; or the first polarization direction may be a right-hand circular polarization direction, and the second polarization direction may be an elliptical polarization direction; or the first polarization direction may be an elliptical polarization direction, and the second polarization direction may be a right-hand circular polarization direction.

In some embodiments, for Manner 3, polarization directions corresponding to different user groups on an uplink time domain resource may be the same, and polarization directions corresponding to different user groups on a downlink time domain resource may be the same.

In some embodiments, if a polarization direction supported by the first terminal device is a linear polarization direction, the first terminal device sends uplink data only on an uplink time domain resource that is allowed to be used, and uses another time domain resource in the first time division duplex frame structure as a special slot, that is, does not receive or send data on the another time domain resource.

To better understand a principle of resolving the technical problem of this solution in any one of Manner 1 to Manner 3, the following provides descriptions with reference to the accompanying drawings.

FIG. 8 is a diagram of a principle description for resolving a technical problem of this solution in Manner 1 according to an embodiment of this application. In FIG. 8, the network device configures a same time division duplex frame structure for a terminal device 1 to a terminal device 3. In other words, the time division duplex frame structure is a frame structure shared by the terminal device 1 to the terminal device 3. Generally, if a time division duplex frame structure configured by the network device is used by one terminal device, when an interval between adjacent uplink time domain resources in the time division duplex frame structure is a timing advance of the terminal device, and uplink data sent by the terminal device by using the timing advance arrives at the network device, a time domain resource that can be used by the network device is exactly an uplink time domain resource, and the network device may receive the uplink data on the uplink time domain resource. However, because the time division duplex frame structure configured by the network device is the frame structure shared by the terminal device 1 to the terminal device 3, in order that when uplink data sent by any one of the terminal device 1 to the terminal device 3 by using a timing advance arrives at the network device, a time domain resource that can be used by the network device is exactly an uplink time domain resource, and the network device can receive the uplink data on the uplink time domain resource, the interval between the adjacent uplink time domain resources in the time division duplex frame structure needs to be determined based on a largest timing advance and a smallest timing advance in the terminal device 1 to the terminal device 3. For example, the interval between the adjacent uplink time domain resources in the time division duplex frame structure is a difference between the largest timing advance and the smallest timing advance in the terminal device 1 to the terminal device 3. If a timing advance of the terminal device 1 is the smallest, a timing advance of the terminal device 2 is the second largest, and a timing advance of the terminal device 3 is the largest, after the terminal device 1 sends uplink data on one uplink time domain resource in the time division duplex frame structure by using the timing advance of the terminal device 1, because the timing advance of the terminal device 1 may be understood as time at which the uplink data of the terminal device 1 arrives at the network device, and the interval between the adjacent uplink time domain resources in the time division duplex frame structure is determined based on the largest timing advance and the smallest timing advance in the terminal device 1 to the terminal device 3, when the uplink data of the terminal device 1 arrives at the network device, a time domain resource that can be used by the network device is exactly an uplink time domain resource. Therefore, the network device can receive the uplink data of the terminal device 1 on the uplink time domain resource. Similarly, after the terminal device 2 and the terminal device 3 separately send uplink data on one uplink time domain resource in the time division duplex frame structure by using respective timing advances, when the uplink data of the terminal device 2 and the terminal device 3 arrives at the network device, a time domain resource that can be used by the network device is exactly an uplink time domain resource. Therefore, the network device can receive the uplink data of the terminal device 2 and the terminal device 3 on the uplink time domain resource.

FIG. 9 is a diagram of a principle description for resolving a technical problem of this solution in Manner 2 according to an embodiment of this application. In FIG. 9, the network device configures a same time division duplex frame structure for all terminal devices in a user group 1. In other words, the time division duplex frame structure is a frame structure shared by all the terminal devices in the user group 1. The user group 1 is one of a plurality of user groups in the cell managed by the network device. In other words, a quantity of the terminal devices in the user group 1 is less than a quantity of terminal devices in the cell managed by the network device. A guard period in the time division duplex frame structure configured by the network device for all the terminal devices in the user group 1 is determined based on a largest timing advance of the user group 1, a timing advance of any terminal device in the user group 1 is less than or equal to the largest timing advance of the user group 1, and the network device does not receive or send data in the guard period. Therefore, after any terminal device in the user group 1 sends uplink data on any uplink time domain resource in the time division duplex frame structure by using a timing advance of the terminal device, when the uplink data arrives at the network device, a time domain resource that can be used by the network device is exactly an uplink time domain resource, so that the network device can receive the uplink data on the uplink time domain resource. For example, with reference to FIG. 9, after a terminal device in the user group 1 sends uplink data on U0, when the uplink data arrives at the network device, a time domain resource that can be used by the network device is exactly U4, so that the network device may receive the uplink data on U4.

FIG. 10 is a diagram of a principle description for resolving a technical problem of this solution in Manner 3 according to an embodiment of this application. In FIG. 10, terminal devices that use a time division duplex frame structure configured by the network device include all terminal devices in a user group 1 and a user group 2. The user group 1 includes a terminal device 1, the user group 2 includes a terminal device 2, and a downlink time domain resource of the terminal device 1 completely overlaps an uplink time domain resource of the terminal device 2. For example, D4 completely overlaps U3 in FIG. 10. This means that when the terminal device 1 receives downlink data on D4, the terminal device 2 sends uplink data on U3. Therefore, there is a problem of a conflict between the downlink data of the terminal device 1 and the uplink data of the terminal device 2. To avoid this problem, the network device may configure a polarization direction 1 for the terminal device 1, and configure a polarization direction 2 for the terminal device 2, where the polarization direction 1 is different from the polarization direction 2. In other words, when the terminal device 1 receives the downlink data on D4 in the polarization direction 1, and the terminal device 2 sends the uplink data on U3 in the polarization direction 2, there is no conflict, interference, and other problems between the downlink data of the terminal device 1 and the uplink data of the terminal device 2.

The foregoing mainly describes the solutions provided in this application from the perspective of interaction between devices. It may be understood that, to implement the foregoing functions, the devices include corresponding hardware structures and/or software modules for performing the functions. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the first device or the second device may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in embodiments of this application, division into the modules is an example, and is merely a logical function division. During actual implementation, another division manner may be used.

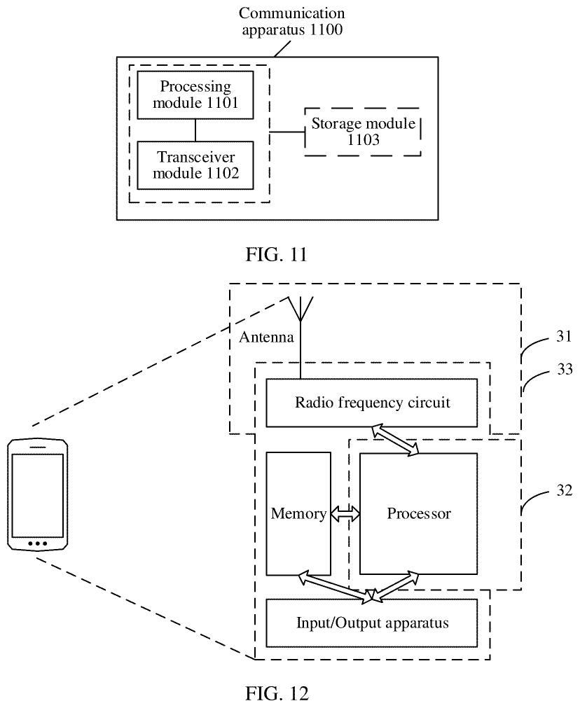

When the integrated module is used, FIG. 11 is a diagram of a structure of a communication apparatus according to an embodiment of this application. The communication apparatus 1100 may be used in the method shown in FIG. 4. As shown in FIG. 11, the communication apparatus 1100 includes a processing module 1101 and a transceiver module 1102. The processing module 1101 may be one or more processors, and the transceiver module 1102 may be a transceiver or a communication interface. The communication apparatus may be configured to implement a function of the first terminal device or the network device in any one of the foregoing method embodiments, or configured to implement a function of the network element in any one of the foregoing method embodiments. The network element or network function may be a network element in a hardware device, a software function running on dedicated hardware, or a virtualization function instantiated on a platform (for example, a cloud platform). In some embodiments, the communication apparatus 1100 may further include a storage module 1103, configured to store program code and data of the communication apparatus 1100.

In an instance, the communication apparatus is used as the first terminal device or a chip used in the first terminal device, and performs the steps performed by the first terminal device in the foregoing method embodiments. The transceiver module 1102 is configured to support communication with the network device and the like. The transceiver module specifically performs a sending and/or receiving action performed by the first terminal device in FIG. 4, for example, supports the first terminal device in performing another process of the technology described in this specification. The processing module 1101 may be configured to support the communication apparatus 1100 in performing the processing action in the foregoing method embodiments, for example, support the first terminal device in performing step 403, and/or is configured to perform another process of the technology described in this specification.

For example, the transceiver module 1102 is configured to: receive first configuration information, where the first configuration information is used to configure a first time division duplex frame structure; and send uplink data on a first uplink time domain resource in the first time division duplex frame structure by using a first timing advance, where an interval between adjacent uplink time domain resources in the first time division duplex frame structure is determined based on a largest timing advance and a smallest timing advance in a terminal device that uses the first time division duplex frame structure.

In an instance, the communication apparatus is used as the network device or a chip used in the network device, and performs the steps performed by the network device in the foregoing method embodiments. The transceiver module 1102 is configured to support communication with the first terminal device and the like. The transceiver module specifically performs a sending and/or receiving action performed by the network device in FIG. 4, for example, supports the network device in performing another process of the technology described in this specification. The processing module 1101 may be configured to support the communication apparatus 1100 in performing the processing action in the foregoing method embodiments, for example, support the network device in performing another process of the technology described in this specification.

For example, the processing module 1101 is configured to generate first configuration information, where the first configuration information is used to configure a first time division duplex frame structure; the transceiver module 1102 is configured to send the first configuration information; and the transceiver module is further configured to receive uplink data on a first uplink time domain resource in the first time division duplex frame structure, where an interval between adjacent uplink time domain resources in the first time division duplex frame structure is determined based on a largest timing advance and a smallest timing advance in a terminal device that uses the first time division duplex frame structure.

In a possible implementation, when the first terminal device or the network device is a chip, the transceiver module 1102 may be a communication interface, a pin, a circuit, or the like. The communication interface may be configured to input to-be-processed data to a processor, and may output a processing result of the processor. During specific implementation, the communication interface may be a general-purpose input/output (general-purpose input/output, GPIO) interface, and may be connected to a plurality of peripheral devices (for example, a display (LCD), a camera (camera), a radio frequency (radio frequency, RF) module, and an antenna). The communication interface is connected to the processor through a bus.

The processing module 1101 may be a processor. The processor may execute computer-executable instructions stored in the storage module, so that the chip performs the method in the embodiments in FIG. 4.

Further, the processor may include a controller, an arithmetic unit, and a register. For example, the controller is mainly responsible for instruction decoding, and transmitting a control signal for an operation corresponding to the instructions. The arithmetic unit is mainly responsible for performing a fixed-point or floating-point arithmetic operation, a shift operation, a logic operation, and the like, and may also perform an address operation and address translation. The register is mainly responsible for storing a quantity of register operations, an intermediate operation result, and the like that are temporarily stored during instruction execution. During specific implementation, a hardware architecture of the processor may be an application-specific integrated circuit (application-specific integrated circuit, ASIC) architecture, a microprocessor without interlocked piped stages architecture (microprocessor without interlocked piped stages architecture, MIPS), an advanced reduced instruction set computing machine (advanced RISC machine, ARM) architecture, a network processor (network processor, NP) architecture, or the like. The processor may be a single-core or multi-core processor.

The storage module may be a storage module inside the chip, for example, a register or a cache. Alternatively, the storage module may be a storage module located outside the chip, for example, a read-only memory (Read-Only Memory, ROM), another type of static storage device that can store static information and instructions, or a random access memory (Random Access Memory, RAM).

It should be noted that a function corresponding to each of the processor and the interface may be implemented by using a hardware design, may be implemented by using a software design, or may be implemented by a combination of software and hardware. This is not limited herein.

FIG. 12 is a diagram of a structure of a simplified first terminal device according to an embodiment of this application. For ease of understanding and illustration, in FIG. 12, a mobile phone is used as an example of the first terminal device. As shown in FIG. 12, the first terminal device includes at least one processor, and may further include a radio frequency circuit, an antenna, and an input/output apparatus. The processor may be configured to process a communication protocol and communication data, and may be further configured to control the first terminal device, execute a software program, process data of the software program, and the like. The first terminal device may further include a memory. The memory is mainly configured to store a software program and data. These related programs may be loaded into the memory when the communication apparatus is delivered from a factory, or may be loaded into the memory when needed later. The radio frequency circuit is mainly configured to: perform conversion between a baseband signal and a radio frequency signal, and process the radio frequency signal. The antenna is mainly configured to receive/send a radio frequency signal in an electromagnetic wave form, and the antenna is the antenna provided in embodiments of this application. The input/output apparatus, such as a touchscreen, a display, or a keyboard, is mainly configured to: receive data input by a user and output data to the user. It should be noted that some types of first terminal devices may have no input/output apparatus.

When data needs to be sent, the processor performs baseband processing on the to-be-sent data, and then outputs a baseband signal to the radio frequency circuit. The radio frequency circuit performs radio frequency processing on the baseband signal, and then sends a radio frequency signal to the outside in a form of an electromagnetic wave through the antenna. When data is sent to the first terminal device, the radio frequency circuit receives a radio frequency signal through the antenna, converts the radio frequency signal into a baseband signal, and outputs the baseband signal to the processor. The processor converts the baseband signal into data, and processes the data. For ease of description, FIG. 12 shows only one memory and one processor. In an actual first terminal device product, there may be one or more processors and one or more memories. The memory may also be referred to as a storage medium, a storage device, or the like. The memory may be disposed independent of the processor, or may be integrated with the processor. This is not limited in this embodiment of this application.

In this embodiment of this application, the antenna and the radio frequency circuit having receiving and sending functions may be considered as a receiving unit and a sending unit (which may also be collectively referred to as a transceiver unit) of the first terminal device, and the processor having a processing function may be considered as a processing unit of the first terminal device. As shown in FIG. 12, the first terminal device includes a receiving module 31, a processing module 32, and a sending module 33. The receiving module 31 may also be referred to as a receiver, a receiving machine, a receiver circuit, or the like. The sending module 33 may also be referred to as a sender, a transmitter, a transmitter machine, a transmitter circuit, or the like. The processing module 32 may also be referred to as a processor, a processing board, a processing apparatus, or the like.

For example, the processing module 32 is configured to perform a function of the first terminal device in the embodiments shown in FIG. 4.

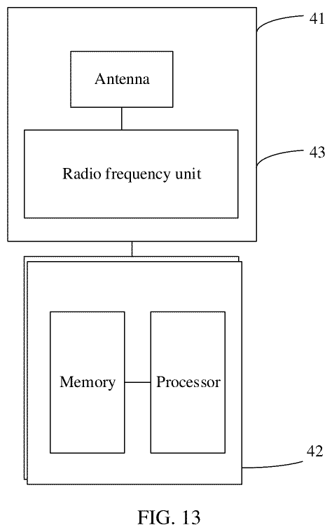

FIG. 13 is a diagram of a structure of a simplified network device according to an embodiment of this application. The network device includes a baseband part 42 and a part for radio frequency signal transmission/reception and conversion. The part for radio frequency signal transmission/reception and conversion further includes a receiving module part 41 and a sending module part 43 (which may also be collectively referred to as a transceiver module). The part for radio frequency signal transmission/reception and conversion is mainly configured to: send/receive a radio frequency signal and perform conversion between a radio frequency signal and a baseband signal. The baseband part 42 is mainly configured to: perform baseband processing, control the network device, and the like. The receiving module 41 may also be referred to as a receiver, a receiving machine, a receiver circuit, or the like. The sending module 43 may also be referred to as a sender, a transmitter, a transmitter machine, a transmitter circuit, or the like. The baseband part 42 is usually a control center of the network device, may also be referred to as a processing module, and is configured to perform the steps performed by the network device in FIG. 4. For details, refer to the foregoing descriptions of the related parts.

The baseband part 42 may include one or more boards. Each board may include one or more processors and one or more memories. The processor is configured to read and execute a program in the memory, to implement a baseband processing function and control the network device. If there are a plurality of boards, the boards may be interconnected to improve a processing capability. In an optional implementation, the plurality of boards may share one or more processors, or the plurality of boards share one or more memories, or the plurality of boards share one or more processors simultaneously.

For example, the sending module 43 is configured to perform a function of the network device in the embodiments shown in FIG. 4.

An embodiment of this application further provides a communication apparatus, including a processor. The processor invokes a computer program stored in a memory to implement the embodiments shown in FIG. 4.

An embodiment of this application further provides a communication apparatus, including a logic circuit and an input/output interface. The logic circuit is configured to read and execute stored instructions, and when the instructions are run, the communication apparatus is enabled to perform the embodiments shown in FIG. 4.

An embodiment of this application further provides a computer-readable storage medium. The computer-readable storage medium stores a computer program. When the computer program is run, the embodiments shown in FIG. 4 are implemented.

An embodiment of this application further provides a computer program product including instructions. When the instructions are executed on a computer, the embodiments shown in FIG. 4 are performed.

The foregoing units described as separate parts may or may not be physically separate, and parts displayed as units may or may not be physical units, may be located in one location, or may be distributed on a plurality of network units. Some or all of the units may be selected based on an actual requirement, to achieve the objectives of the solutions in embodiments of this application. In addition, network element units in embodiments of this application may be integrated into one processing unit, or each unit may exist alone physically, or two or more units are integrated into one unit. The integrated unit may be implemented in a form of hardware, or may be implemented in a form of a software network element unit.

When the integrated unit is implemented in the form of the software network element unit and sold or used as an independent product, the integrated unit may be stored in a computer-readable storage medium. Based on such an understanding, an essentially contributing part in the technical solutions of this application, or all or some of the technical solutions may be embodied in a form of a software product. The computer software product is stored in a storage medium and includes several instructions for instructing a computer device (which may be a personal computer, a terminal device, a cloud server, a network device, or the like) to perform all or some of the steps of the method in embodiments of this application. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc. The foregoing descriptions are merely specific implementations of this application, but are not intended to limit the protection scope of this application. Any equivalent modification or replacement readily figured out by a person skilled in the art within the technical scope disclosed in this application shall fall within the protection scope of this application. Therefore, the protection scope of this application shall be subject to the protection scope of the claims.

1. A resource configuration method, comprising:
receiving, by a first terminal device, first configuration information, wherein the first configuration information is used to configure a first time division duplex frame structure; and
sending, by the first terminal device, uplink data on a first uplink time domain resource in the first time division duplex frame structure by using a first timing advance, wherein
an interval between adjacent uplink time domain resources in the first time division duplex frame structure is determined based on a largest timing advance and a smallest timing advance in a terminal device that uses the first time division duplex frame structure.

2. The method according to claim 1, wherein the interval between the adjacent uplink time domain resources in the first time division duplex frame structure is a difference between the largest timing advance and the smallest timing advance in the terminal device that uses the first time division duplex frame structure.

3. The method according to claim 1, wherein
the terminal device that uses the first time division duplex frame structure comprises all terminal devices in a cell managed by the network device; or
the terminal device that uses the first time division duplex frame structure comprises all terminal devices in one or more user groups, and the one or more user groups comprise a first user group to which the first terminal device belongs.

4. The method according to claim 3, wherein an interval between adjacent uplink time domain resources corresponding to each user group in the first time division duplex frame structure is determined based on a largest timing advance and a smallest timing advance of the user group.

5. The method according to claim 4, wherein the first timing advance is greater than or equal to a smallest timing advance of the first user group and is less than a largest timing advance of the first user group, and the first uplink time domain resource is an uplink time domain resource corresponding to the first user group.

6. The method according to claim 3, wherein the first user group is associated with a first bandwidth part, and time domain resources of the first user group in the first bandwidth part have one transmission direction.

7. The method according to claim 6, wherein the plurality of user groups further comprise a second user group, the second user group is associated with a second bandwidth part, and an uplink time domain resource of the first user group in the first bandwidth part is different from an uplink time domain resource of the second user group in the second bandwidth part.

8. The method according to claim 1, wherein a guard period in the first time division duplex frame structure is determined based on the largest timing advance of the first user group to which the first terminal device belongs, and the first user group is one of a plurality of user groups in the cell managed by the network device.

9. The method according to claim 8, wherein a difference between the largest timing advance and the smallest timing advance of the first user group is less than a difference between a largest timing advance and a smallest timing advance in the cell managed by the network device.

10. The method according to claim 1, wherein the method further comprises:
receiving, by the first terminal device, second configuration information, wherein the second configuration information is used to configure at least one of the following: the guard period in the first time division duplex frame structure and the interval between the adjacent uplink time domain resources in the first time division duplex frame structure.

11. A communication apparatus, wherein the communication apparatus is a first terminal device, the first terminal device comprises a transceiver, and the transceiver is configured to:
receive first configuration information, wherein the first configuration information is used to configure a first time division duplex frame structure; and
send uplink data on a first uplink time domain resource in the first time division duplex frame structure by using a first timing advance, wherein
an interval between adjacent uplink time domain resources in the first time division duplex frame structure is determined based on a largest timing advance and a smallest timing advance in a terminal device that uses the first time division duplex frame structure.

12. The apparatus according to claim 11, wherein the interval between the adjacent uplink time domain resources in the first time division duplex frame structure is a difference between the largest timing advance and the smallest timing advance in the terminal device that uses the first time division duplex frame structure.

13. The apparatus according to claim 11, wherein
the terminal device that uses the first time division duplex frame structure comprises all terminal devices in a cell managed by the network device; or
the terminal device that uses the first time division duplex frame structure comprises all terminal devices in one or more user groups, and the one or more user groups comprise a first user group to which the first terminal device belongs.

14. The apparatus according to claim 13, wherein an interval between adjacent uplink time domain resources corresponding to each user group in the first time division duplex frame structure is determined based on a largest timing advance and a smallest timing advance of the user group.

15. The apparatus according to claim 14, wherein the first timing advance is greater than or equal to a smallest timing advance of the first user group and is less than a largest timing advance of the first user group, and the first uplink time domain resource is an uplink time domain resource corresponding to the first user group.

16. The apparatus according to claim 13, wherein the first user group is associated with a first bandwidth part, and time domain resources of the first user group in the first bandwidth part have one transmission direction.

17. The apparatus according to claim 16, wherein the plurality of user groups further comprise a second user group, the second user group is associated with a second bandwidth part, and an uplink time domain resource of the first user group in the first bandwidth part is different from an uplink time domain resource of the second user group in the second bandwidth part.

18. The apparatus according to claim 11, wherein a guard period in the first time division duplex frame structure is determined based on the largest timing advance of the first user group to which the first terminal device belongs, and the first user group is one of a plurality of user groups in the cell managed by the network device.

19. The apparatus according to claim 18, wherein a difference between the largest timing advance and the smallest timing advance of the first user group is less than a difference between a largest timing advance and a smallest timing advance in the cell managed by the network device.

20. The apparatus according to claim 11, wherein
the transceiver module is further configured to receive second configuration information, wherein the second configuration information is used to configure at least one of the following: the guard period in the first time division duplex frame structure and the interval between the adjacent uplink time domain resources in the first time division duplex frame structure.
